(19) United States
(12) Patent Application Publication
(10) Pub. No.: US 2024/0305720 A1
(43) Pub. Date: Sep. 12, 2024

(54) IMAGE FORMING SYSTEM AND METHOD OF CONTROLLING IMAGE FORMING SYSTEM

(71) Applicant: KONICA MINOLTA, INC., Tokyo (JP)

(72) Inventor: Isao YAMASHITA, Tokyo (JP)

(21) Appl. No.: 18/593,737

(22) Filed: Mar. 1, 2024

(30) Foreign Application Priority Data
Mar. 10, 2023 (JP) 2023-037623

(51) Int. Cl. H04N 1/00; H04N 1/60

(52) U.S. Cl. CPC H04N 1/00029; H04N 1/00087; H04N 1/00713; H04N 1/6008

(57) ABSTRACT

An image forming system includes an image former, a first reader, and a second reader. The image former forms an image on a recording medium. The first reader is provided upstream of an image former 300 in a conveyance direction of the recording medium, and reads the recording medium. The second reader is provided downstream of the image former 300 in the conveyance direction of a recording medium S and reads the recording medium S. The first reader and the second reader control each other based on the respective reading results.

### CROSS-REFERENCE TO RELATED APPLICATION

Japanese patent application No. 2023-037623 filed on Mar. 10, 2023, including description, claims, drawings, and abstract the entire disclosure is incorporated herein by reference in its entirety.

### BACKGROUND OF THE INVENTION

### 1. Technical Field

The present invention relates to an image forming system and a method of controlling an image forming system.

### 2. Description of Related Art

An image forming system is known in which sheet readers are installed at a plurality of places on a sheet conveyance path and a reading operation is performed on a conveyed sheet in order to improve accuracy in sheet conveyance control, cutting position control, printing position control, and the like (for example, Japanese Unexamined Patent Application Publication No. 2021-105629).

### SUMMARY OF THE INVENTION

However, in the image forming system including the plurality of sheet readers, it takes time for a service technician to identify a failed location due to complication of a configuration. Therefore, there is a possibility that time during which the image forming system cannot be used due to a failure (that is, downtime) increases.

The present invention has been made in consideration of the above-described circumstances, and an object of the present invention is to provide an image forming system capable of suppressing an increase in downtime due to complication of a configuration of an image forming system, and a method of controlling the image forming system.

To achieve at least one of the abovementioned objects, according to an aspect of the present invention, an image forming system reflecting one aspect of the present invention comprises the followings.

An image forming system including: an image former that forms an image on a recording medium; a first reader that is provided upstream of the image former in a conveyance direction of the recording medium and reads the recording medium; and a second reader that is provided downstream of the image former in the conveyance direction of the recording medium and reads the recording medium, in which the first reader controls the second reader based on a reading result of the first reader, and the second reader controls the first reader based on a reading result of the second reader.

To achieve at least one of the abovementioned objects, according to an aspect of the present invention, an image forming system reflecting one aspect of the present invention comprises the followings.

An image forming system including: an image former that form an image on a recording medium; a first reader that is provided upstream of the image former in a conveyance direction of the recording medium and reads the recording medium; a second reader that is provided downstream of the image former in the conveyance direction of the recording medium and reads the recording medium; and a determiner that determines an abnormality of at least one of the first reader or the second reader based on a reading result of the first reader and a reading result of the second reader.

### BRIEF DESCRIPTION OF THE DRAWINGS

FIG. 1 is a schematic block diagram of a printing system according to a first embodiment of the present invention;

FIG. 2 is a schematic block diagram exemplifying a hardware configuration of a printer controller illustrated in FIG. 1;

FIG. 3 is a diagram exemplifying a schematic configuration of an image forming system illustrated in FIG. 1;

FIG. 4 is a schematic block diagram of the image forming system illustrated in FIG. 1;

FIG. 5 is a schematic block diagram illustrating a configuration of a controller of the image forming system illustrated in FIG. 4;

FIG. 6 is a conceptual diagram for describing control of aligning the positions of images formed on front and back of a sheet (feedforward front-back alignment control);

FIG. 7 is a flowchart exemplifying a processing procedure of a method of controlling the image forming system illustrated in FIG. 1;

FIG. 8 is a schematic block diagram of a printing system according to a second embodiment of the present invention;

FIG. 9 is a conceptual diagram for describing feedforward front-back alignment control of a sheet in the second embodiment;

FIG. 10 is a flowchart exemplifying a processing procedure of a method of controlling an image forming system illustrated in FIG. 8;

FIG. 11 is a flowchart exemplifying a processing procedure of a method of controlling a printing system according to a third embodiment of the present invention;

FIG. 12 is a flowchart exemplifying a processing procedure of a method of controlling a printing system according to a fourth embodiment of the present invention;

FIG. 13 is a schematic diagram exemplifying an image to be formed which is planned to be formed on a sheet;

FIG. 14A is a schematic diagram exemplifying a blank image when a first reading device is normal;

FIG. 14B is a schematic diagram exemplifying a blank image when the first reading device is abnormal;

FIG. 15A is a schematic diagram exemplifying a composite image when the first reading device is normal;

FIG. 15B is a schematic diagram exemplifying a composite image when the first reading device is abnormal;

FIG. 16A is a schematic diagram exemplifying a pixel gradation total value of a composite image when the first reading device is normal;

FIG. 16B is a schematic diagram exemplifying a pixel gradation total value of a composite image when the first reading device is abnormal;

FIG. 17 is a schematic diagram exemplifying a formed image;

FIG. 18 is a schematic diagram exemplifying a pixel gradation total value of the formed image;

FIG. 19 is a flowchart exemplifying a processing procedure of a method of controlling a printing system according to a fifth embodiment of the present invention;

FIG. 20 is a schematic diagram exemplifying a formed image when a second reading device is abnormal; and

FIG. 21 is a schematic diagram exemplifying a pixel gradation total value of a formed image when the second reading device is abnormal.

### DETAILED DESCRIPTION

Hereinafter, one or more embodiments of the present invention will be described with reference to the drawings. However, the scope of the invention is not limited to the disclosed embodiments.

In the description of the drawings, the same elements are denoted by the same reference signs, and redundant description thereof will be omitted. In addition, dimensional ratios in the drawings are exaggerated for convenience of description and may be different from actual ratios.

### First Embodiment

### <Configuration of Printing System>

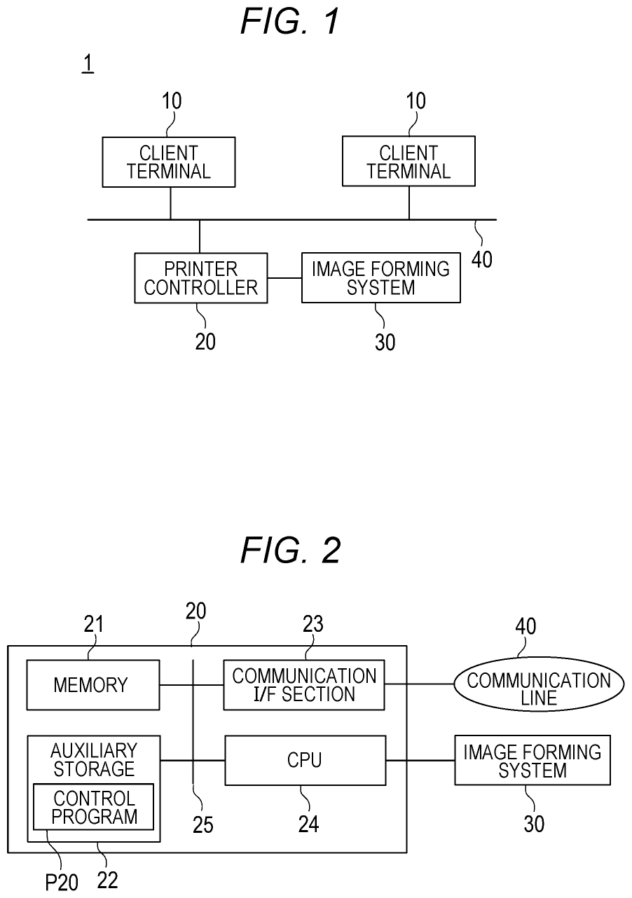

FIG. 1 is a schematic block diagram for describing a configuration of a printing system 1 according to a first embodiment of the present invention. As illustrated in FIG. 1, the printing system 1 includes a client terminal 10, a printer controller 20, and an image forming system 30. The client terminal 10, the printer controller 20, and the image forming system 30 are communicably connected to each other via a communication line 40.

The client terminal 10 can be, for example, a personal computer, a tablet terminal, a smartphone, or the like. A printer driver for converting document data into a print job is installed in the client terminal 10. The printer driver generates a print job in a format compatible with the printer controller 20, and transmits the print job to the printer controller 20 through the communication line 40.

The print job includes, for example, print data and print setting data in a page description language (PDL) format. The print setting data includes information about the number of pages, the number of copies, the type, size, and grammage of a sheet, a setting of an inspection function, a setting of single-sided printing or double-sided printing, and the like.

The communication line 40 can include a local area network (LAN) in which computers or network devices are connected to each other in accordance with standards such as Ethernet (registered trademark), fiber distributed data interface (FDDI), and wireless fidelity (Wi-Fi), a wide area network (WAN) in which LANs are connected to each other by a dedicated line, or the like.

Note that the number of constituent elements connected to the communication line 40 is not limited to the case exemplified in FIG. 1.

### <Configuration of Printer Controller>

FIG. 2 is a schematic block diagram exemplifying a hardware configuration of the printer controller 20 illustrated in FIG. 1. The printer controller 20 generates print image data and transmits the print image data to the image forming system 30.

The printer controller 20 includes a memory 21, an auxiliary storage 22, a communication I/F section 23, and a central processing unit (CPU) 24, and these constituent elements are connected by an internal bus 25. The memory 21 includes a random access memory (RAM) and a read only memory (ROM) (not illustrated). The RAM is a high-speed accessible main storage device that temporarily stores a program and transmission/reception data as a work area. The ROM stores various programs and various data.

The auxiliary storage 22 includes, for example, a large-capacity storage device such as a solid state drive (SSD) or a hard disk drive (HDD), and stores various programs including an operating system, a control program P20, and the like.

The communication I/F section 23 is an interface for transmitting and receiving data to and from the client terminal 10 via the communication line 40.

The CPU24 executes various kinds of determination processing and calculation processing in order to generate print image data in accordance with the various programs and control the communication I/F section 23 and the image forming system 30. The functions of the printer controller 20 are implemented by the CPU 24 executing programs respectively corresponding to the functions. The printer controller 20 analyzes the print job received from the client terminal 10 via the communication line 40. The printer controller 20 executes processing such as color conversion, screening, and rasterizing, and generates print image data in a bitmap format.

### <Configuration of Image Forming System>

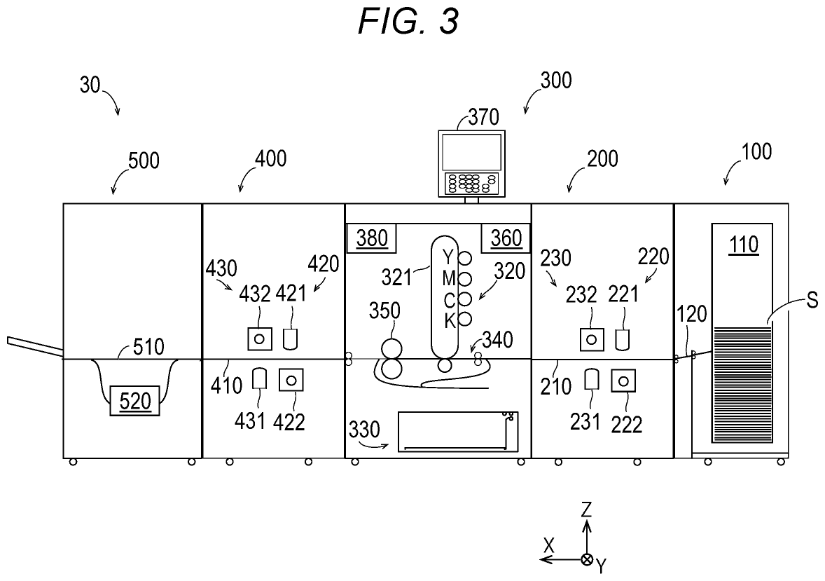

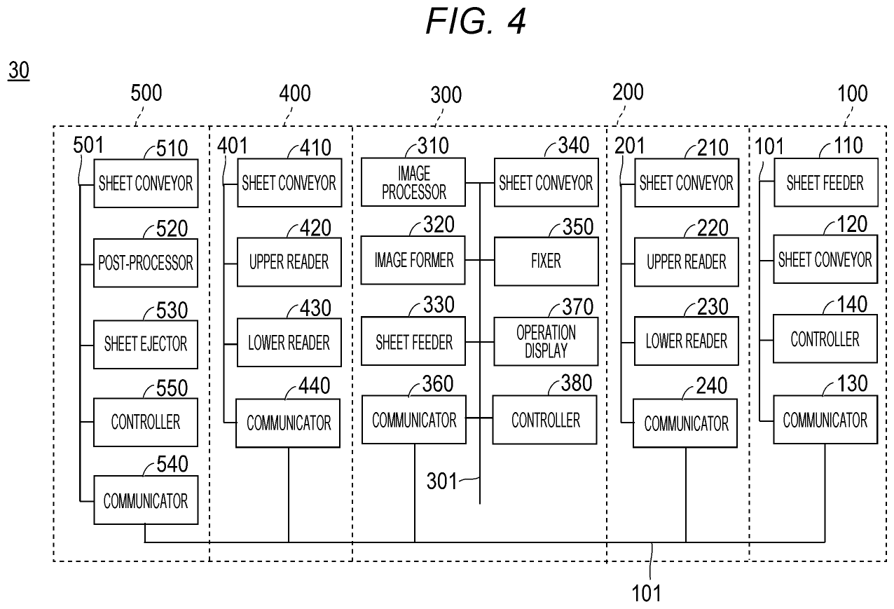

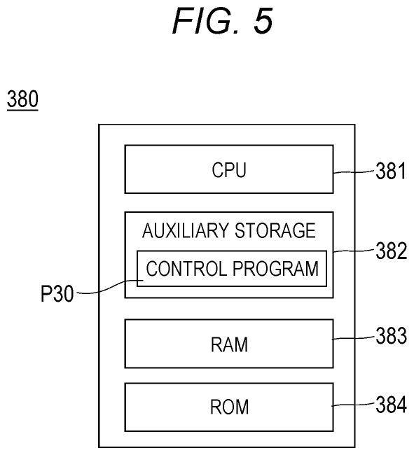

FIG. 3 is a diagram exemplifying a schematic configuration of the image forming system 30 illustrated in FIG. 1, and FIG. 4 is a schematic block diagram of the image forming system 30 illustrated in FIG. 1. FIG. 5 is a schematic block diagram illustrating a configuration of a controller 380 of the image forming system 30 illustrated in FIG. 4.

As illustrated in FIG. 3, the image forming system 30 of the present embodiment includes a sheet feed device 100, a first reading device 200, an image forming apparatus 300, a second reading device 400, and a post-processing device 500 that are connected in series in an X direction (conveyance direction). Note that the configuration of the image forming system 30 illustrated in FIG. 3 is an example, and the type and the number of devices included in the image forming system 30 are not limited to the example illustrated in FIG. 1.

### <Sheet Feed Device 100>

The sheet feed device 100 supplies a sheet as a recording medium to the first reading device 200 in response to an instruction of the image forming apparatus 300. As illustrated in FIG. 4, the sheet feed device 100 includes a sheet feeder 110, a sheet conveyor 120, a communicator 130, and a controller 140. The sheet feeder 110, the sheet conveyor 120, the communicator 130, and the controller 140 are connected to each another by an internal bus 101.

The sheet feeder 110 includes at least one sheet feed tray and accommodates sheets to be used for printing. Sheets S accommodated in the sheet feed tray are supplied one by one to the first reading device 200 by a plurality of conveyance roller pairs along a sheet conveyance path of the sheet conveyor 120. Note that the recording medium is not limited to a paper sheet, and may be a film-like sheet or the like.

The communicator 130 exchanges a control signal or data with the image forming apparatus 300. The controller 140 controls the sheet feeder 110, the sheet conveyor 120, and the communicator 130 by executing a control program for the sheet feed device 100.

### <First Reading Device 200>

In response to an instruction from the controller 380, the first reading device 200 reads the sheet S conveyed from the sheet feed device 100. The first reading device 200 includes a sheet conveyor 210, an upper reader 220, a lower reader 230, and a communicator 240. These constituent elements are communicably connected to each other via an internal bus 201. The upper reader 220 and/or the lower reader 230 constitute a first reader.

The sheet conveyor 210 includes a sheet conveyance path and a plurality of conveyance roller pairs and conveys the sheet S supplied from the sheet feed device 100 toward the image forming apparatus 300 along the sheet conveyance path.

The upper reader 220 includes an upper scanner 221 installed on an upper side of the sheet conveyance path of the sheet conveyor 210, and a first background member 222 opposed to the upper scanner 221 and installed on a lower side of the sheet conveyance path. The lower reader 230 includes a lower scanner 231 installed on the lower side of the sheet conveyance path of the sheet conveyor 210, and a second background member 232 opposed to the lower scanner 231 and installed on the upper side of the sheet conveyance path.

The upper scanner 221 includes an optical system including an image sensor, a lens, and a mirror, a light emitting diode (LED) light source, and a controller. The lower scanner 231 has a similar configuration to the upper scanner 221. The upper scanner 221 and the lower scanner 231 are configured to be operable independently of each other.

The image sensor can be, for example, a charge coupled device (CCD) line sensor or a complementary metal oxide semiconductor (CMOS) line sensor. The upper scanner 221 and the lower scanner 231 may be configured by using a contact image sensor (CIS). The controller includes a CPU, memories (RAM and ROM), an auxiliary storage, and the like, controls the optical system and the light source, and thus implements various functions as a color scanner, such as a function of reading a color image.

The first background member 222 is, for example, a member having a prismatic shape (for example, a quadrangular prism shape), and a plurality of side surfaces of the member have different colors (for example, black and white). The controller of the upper reader 220 controls a drive source (not illustrated) to rotate a central axis of the first background member 222. Accordingly, the controller of the upper reader 220 can change a background used for reading the sheet S to a different color (black or white). For example, when a white or light-colored sheet S is read, a black surface of the first background member 222 can be used as the background. When a black or dark-colored sheet S is read, a white surface of the first background member 222 can be used as the background. The second background member 232 has a similar configuration to the first background member 222.

The upper scanner 221 is configured to be able to read an area in a range wider than a size (length and width) of the sheet S when the sheet S is conveyed on the sheet conveyance path on the first background member 222. The size of the sheet S includes the four sides of the sheet S and a part of the first background member 222 near the four sides. Similarly, the lower scanner 231 is configured to be able to read a range wider than the size of the sheet S including the four sides of the sheet S and a part of the second background member 232 near the four sides when the sheet S is conveyed on the sheet conveyance path on the first background member 222.

Specifically, the upper scanner 221 reads a range wider than the width of the sheet S on a front surface (upper surface) in a main scanning direction (Y direction) orthogonal to the X direction (sheet conveyance direction) in which the sheet S is conveyed. The upper scanner 221 repeats reading of the sheet S a plurality of times while the sheet S is being conveyed on the sheet conveyance path by the sheet conveyor 210, to acquire read image data of the front surface of the sheet S. Furthermore, the lower scanner 231 reads a range wider than the width of the sheet S in a width direction on a back surface (lower surface) of the sheet S. The lower scanner 231 repeats reading of the sheet S a plurality of times while the sheet S is being conveyed on the sheet conveyance path to acquire read image data of the back surface of the sheet S. The read image data of the front surface and the back surface read by the upper scanner 221 and the lower scanner 231 is transmitted to the controller 380 of the image forming system 30. Note that instead of using a line sensor as the image sensor, read image data may be acquired by using a sensor that reads an image by scanning pixels in the X direction.

The upper scanner 221 detects a leading end and a trailing end of the sheet S, for example, based on a change in a read value of the sheet S in the sheet conveyance direction. For example, in the sheet conveyance direction, the leading end of the sheet S can be detected based on a change in the read value from black to white, and the trailing end of the sheet S can be detected based on a change in the read value from white to black. In addition, the upper scanner 221 detects a left end and a right end of the sheet S based on a change in a read value in the main scanning direction for the sheet S conveyed on the sheet conveyance path. For example, the left end of the sheet S can be detected based on a change in the read value from black to white, and the right end of the sheet S can be detected based on a change in the read value from white to black.

The upper scanner 221 can calculate an outer shape of the sheet S based on the detected leading end, trailing end, left end, and right end of the sheet S. In the present specification, the outer shape of the sheet S means a length of the sheet S in the sheet conveyance direction (hereinafter, simply referred to as a “length of the sheet”) and a length of the sheet in a direction orthogonal to the sheet conveyance direction (hereinafter, referred to as a “width of the sheet”). Specifically, the upper scanner 221 can calculate a length MPL of the sheet S on the basis of a difference (time difference) between detection timings of the leading end and the trailing end of the sheet S and a sheet conveyance speed. The upper scanner 221 can calculate a width MPW of the sheet S based on a difference between the position of the left end and the position of the right end of the sheet S. Similarly to the upper scanner 221, the lower scanner 231 can also calculate the outer shape of the sheet S (the length MPL and the width MPW of the sheet S) based on the leading end, the trailing end, the left end, and the right end of the sheet S.

The first reading device 200 outputs the length MPL and the width MPW of the sheet S measured by one of the upper scanner 221 or the lower scanner 231. Alternatively, it is also possible to adopt a configuration in which a mean value MPL (=(L1+L2)/2) of a length (L1) of the sheet S measured by the upper scanner 221 and a length (L2) of the sheet S measured by the lower scanner 231 is output. Furthermore, it is also possible to adopt a configuration in which a mean value MPW (=(W1+W2)/2) of a width (W1) of the sheet S measured by the upper scanner 221 and a width (W2) of the sheet S measured by the lower scanner 231 is output.

The communicator 240 exchanges a control signal or read image data between the upper scanner 221 and the lower scanner 223, and the image forming apparatus 300.

### <Image Forming Apparatus 300>

The image forming apparatus 300 receives print image data from the printer controller 20 and prints an image on the sheet S based on the print image data.

In the present embodiment, it is assumed that the image forming apparatus 300 forms an image on one side at a time when double-sided printing is set in the print setting data. That is, the image forming apparatus 300 is configured to form an image on one surface (front surface) of the sheet S, reverse the front and back of the sheet S, and form an image on the other surface (back surface) of the sheet S.

The image forming apparatus 300 includes an image processor 310, an image former 320, a sheet feeder 330, a sheet conveyor 340, a fixer 350, a communicator 360, an operation display 370, and a controller 380. These constituent elements are communicably connected to each other via an internal bus 301.

The image processor 310 performs image processing, such as gamma correction, screen correction, and density balance, on the print image data received by the communicator 360. The image processor 310 transmits the processed image data to the image former 320.

The image former 320 forms an image on the sheet S based on image data by using a known image forming process such as an electrophotographic method including steps of charging, exposing, developing, and transferring. The image former 320 includes, for each color of yellow (Y), magenta (M), cyan (C), and black (K), a photosensitive drum as an image bearing member and a charger, an optical writer, a developing device, and a transferer that are disposed around the photosensitive drum.

Toner images in yellow (Y), magenta (M), cyan (C), and black (K) are formed on the respective photosensitive drums. The toner images are sequentially superimposed and primarily transferred to an intermediate transfer belt 321 of the transferer. The toner image primarily transferred to the intermediate transfer belt 321 is secondarily transferred to the sheet S.

The sheet feeder 330 supplies a sheet to the image former 320. The sheet feeder 330 includes a plurality of sheet feed trays and the sheet feed trays can respectively accommodate, for example, sheets of different sizes such as A4 and A3 sizes.

The sheet conveyor 340 includes a sheet conveyance path and a plurality of conveyance roller pairs and conveys the sheet S in the image forming apparatus 300. The sheet conveyor 340 also includes a sheet inverter and a circulation conveyor. The sheet conveyor 340 can invert the front and back of the sheet S subjected to fixing and eject the sheet S or can form an image on both surfaces of the sheet S.

The fixer 350 fixes a toner image formed on the sheet S. The fixer 350 includes a hollow heating roller inside which a heater is disposed and a pressure roller opposed to the heating roller. The heating roller and the pressure roller are controlled to be at a predetermined temperature (for example, 160° C. or more) by the heater and heated and pressed to the sheet S to fix the toner image.

The sheet S to which an image has been fixed is supplied to the second reading device 400 through a sheet ejector (not illustrated).

The communicator 360 is connected to, for example, the printer controller 20 via a network, and transmits and receives data such as print image data.

The operation display 370 includes an input section and an output section. The input section includes, for example, a keyboard, buttons, and a touch screen. The input section is used for a user to perform various instructions (inputs) such as character input by the keyboard, various settings, and an instruction to start printing by a print start button. The output section includes a display and is used to present the user with an execution status of a print job and the like.

The controller 380 controls the image processor 310, the image former 320, the sheet feeder 330, the sheet conveyor 340, the fixer 350, the communicator 360, and the operation display 370. As illustrated in FIG. 5, the controller 380 includes a CPU 381, an auxiliary storage device 382, a RAM 383, and a ROM 384.

The CPU 381 implements various functions by executing a control program P30 for the image forming apparatus 300. The control program P30 is stored in the auxiliary storage device 382 and is loaded onto the RAM 383 when the program is executed by the CPU 381.

The auxiliary storage device 382 includes, for example, a large-capacity storage device such as an SSD and an HDD. The RAM 383 stores a calculation result and the like accompanied by the execution of the CPU 381. The ROM 384 stores various parameters, various programs, and the like.

### <Second Reading Device 400>

The second reading device 400 reads a print image printed on the sheet S conveyed from the image forming apparatus 300 in response to an instruction from the controller 380. The second reading device 400 includes a sheet conveyor 410, an upper reader 420, a lower reader 430, and a communicator 440. These constituent element are communicably connected to each other via an internal bus 401. The sheet conveyor 410 and the communicator 440 have the same configurations as the sheet conveyor 210 and the communicator 240, respectively, in the first reading device 200. Therefore, the sheet conveyor 410 and the communicator 440 will not be described in detail. The upper reader 420 and/or the lower reader 430 constitute a second reader.

The upper reader 420 includes an upper scanner 421 installed on the upper side of a sheet conveyance path of the sheet conveyor 410, and a first background member 422 opposed to the upper scanner 421 and installed on the lower side of the sheet conveyance path. The lower reader 430 includes a lower scanner 431 installed on the lower side of the sheet conveyance path of the sheet conveyor 410, and a second background member 432 opposed to the lower scanner 241 and installed on the upper side of the sheet conveyance path.

The upper scanner 421 acquires read image data of the front surface of the sheet S by repeatedly scanning and reading an image formed on the front surface of the sheet S a plurality of times in the main scanning direction while the sheet S is being conveyed on the sheet conveyance path by the sheet conveyor 410. The lower scanner 431 acquires read image data of the back surface of the sheet S by repeatedly scanning and reading an image formed on the back surface of the sheet S in the main scanning direction a plurality of times while the sheet S is being conveyed on the sheet conveyance path by the sheet conveyor 410. The read image data of the front surface and the back surface read by the upper scanner 421 and the lower scanner 431 is transmitted to the controller 380 of the image forming system 30.

### <Post-Processing Device 500>

The post-processing device 500 conveys or post-processes the sheet S supplied from the second reading device 400 in response to an instruction of the controller 380 and ejects the sheet S to outside of the image forming system 30. The post-processing device 500 includes a sheet conveyor 510, a post-processor 520, a sheet ejector 530, a communicator 540, and a controller 550. These constituent elements are communicably connected to each other via an internal bus 501.

The sheet conveyor 510 includes a sheet conveyance path and a plurality of conveyance roller pairs. The sheet conveyor 510 conveys the sheet S supplied from the second reading device 400 along the sheet conveyance path, and supplies the sheet S to the post-processor 520 or the sheet ejector 530.

The post-processor 520 performs post-processing on the conveyed sheet S. Examples of the post-processing include punching, cutting, and the like.

The sheet ejector 530 includes a sheet ejection tray and a sheet ejection roller pair. The sheet ejector 530 ejects, to the sheet ejection tray, the sheet S supplied from the second reading device 400 and conveyed along the sheet conveyance path or the post-processed sheet S.

The communicator 540 exchanges a control signal or data between the controller 550 and the image forming apparatus 300. The controller 550 controls the sheet conveyor 510, the post-processor 520, the sheet ejector 530, and the communicator 540. The hardware configuration of the controller 550, which is similar to the hardware configuration of the controller 380, will not be described in detail.

### <Front-Back Alignment Control>

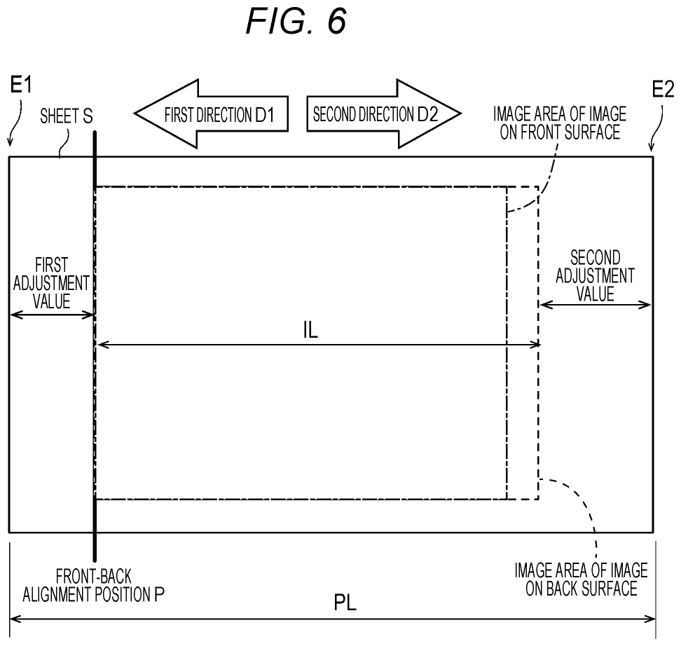

FIG. 6 is a conceptual diagram for describing control of aligning the positions of images formed on the front and back of the sheet S (feedforward front-back alignment control). In the drawing, areas (areas indicated by one dot chain lines and broken lines in the drawing) of the images formed on both surfaces of the sheet S as viewed from the front surface of the sheet S are illustrated so as to overlap each other. As described above, the image forming apparatus 300 of the present embodiment is an image forming apparatus that forms images on both surfaces of the sheet S, one surface at a time, and is configured to form an image on the front surface of the sheet S, then invert the sheet S, and form an image on the back surface of the sheet S. When images are formed on both surfaces of the sheet S in the image forming apparatus having such a configuration, control is performed such that the position of the image formed on the back surface is aligned with the position of the image formed on the front surface in the sheet conveyance direction. Note that, in the present embodiment, a case is exemplified where the image on the back surface is longer than the image on the front surface in the sheet conveyance direction and the image on the front surface and the image on the back surface have the same width in the main scanning direction.

In the drawing, for example, the sheet conveyance direction when an image is formed on the front surface of the sheet S is defined as a first direction D1 (a direction from right to left in the drawing). Then, the sheet conveyance direction when an image is formed on the back surface of the sheet S is a second direction D2 (from left to right in the drawing) opposite to the first direction D1. When an image is formed on the front surface of the sheet S, the controller 380 controls the image former 320 to form an image from a position (image formation position on the front surface) separated by a first adjustment value in the direction from a leading end (E1) to a trailing end (E2) of the sheet S at the time of image formation on the front surface. The first adjustment value is, for example, input in advance by the user and stored in the auxiliary storage device 382. A range indicated by a one dot chain line in the figure indicates an image area of the image on the front surface.

On the other hand, when an image is formed on the back surface of the sheet S, the controller 380 controls image formation on the back surface by the image former 320 so that the position of an end of the image area on the front surface and the position of an end of the image area on the back surface coincide with each other at a front-back alignment position P. A range indicated by a broken line represents the image area of the image on the back surface.

Specifically, the controller 380 forms the image on the back surface in the range indicated by the broken line. Therefore, the controller 380 controls the image former 320 to form an image from a position separated by a second adjustment value in the direction from the leading end (E2) to the trailing end (E1) of the sheet S at the time of image formation on the back surface to an image formation position on the back surface. Here, the second adjustment value is calculated by PL−(first adjustment value+IL), where PL is a length of the sheet S in the D2 direction, and IL is a length of the image on the back surface in the D2 direction. For example, the IL can be acquired (calculated) based on image data. PL can be acquired based on a measurement result of the first reading device 200. The reason is as follows.

The image formation position on the back surface is calculated based on the length PL of the sheet S in the D2 direction. Therefore, if the lengths PL of the sheets supplied from the sheet feed device 100 in the D2 direction are always constant, the image formation positions on the back surface are also always constant, and the image formation positions on the front and back also coincide with each other. However, when there is a variation in the length PL of each sheet supplied from the sheet feed device 100, the image formation position on the back surface changes. As a result, a deviation occurs between the image formation positions on the front and back. Therefore, in the feedforward front-back alignment control of the present embodiment, the controller 380 measures the length PL of the sheet S in the D2 direction in the first reading device 200 and calculates the second adjustment value by using the measured length MPL. Accordingly, an image is formed on the back surface at the image formation position corresponding to the measured length MPL of the sheet S, and thus, the image formation positions on the front and back coincide with each other.

In this way, by controlling the position of the image on the back surface of the sheet S from the leading end of the sheet S (for example, the second adjustment value) in accordance with the first adjustment value set in advance for the front surface of the sheet S, the image formation positions on the front surface and the back surface can be controlled to be the front-back alignment position P.

### <Method of Controlling Image Forming System 30>

As long as the length PL of the sheet S is measured accurately by the first reading device 200, the positions of the images formed on the front and back always coincide with each other by the feedforward front-back alignment control. However, when an error occurs in the measurement of the length PL of the sheet S by the first reading device 200, a deviation occurs in the positions of the images formed on the front and back. It is therefore possible to determine an abnormality (including a failure) of the first reading device 200 based on whether the image formation positions on the front and back coincide with each other. That is, it can be determined that the first reading device 200 is normal when the image formation positions on the front and back coincide with each other, that is, when the alignment of the images on the front and back is correctly performed, and it can be determined that the first reading device 200 is abnormal when the image formation positions on the front and back do not coincide with each other.

Whether the image formation positions on the front and back coincide with each other can be determined by using markers called register marks for positional deviation detection (hereinafter, simply referred to as “register marks”). Specifically, the image former 320 forms an image including register marks on the sheet S at specific positions (for example, four corners of the image) of each of the images to be formed on the front surface and the back surface, and the second reading device 400 reads the register marks formed on each of the front surface and the back surface of the sheet S. When the positions of the register marks corresponding to the front-back alignment positions P on both the front surface and the back surface coincide with each other as a result of reading by the second reading device 400, it is determined that the image formation positions on the front surface and the back surface coincide with each other. For example, when a ratio of an area in which register marks on the front and back overlap is greater than or equal to a predetermined threshold value, it is determined that the positions of the register marks coincide with each other. On the other hand, when the positions of the register marks corresponding to the front-back alignment positions P on both the front surface and the back surface do not coincide with each other, it is determined that the image formation positions on the front surface and the back surface do not coincide with each other.

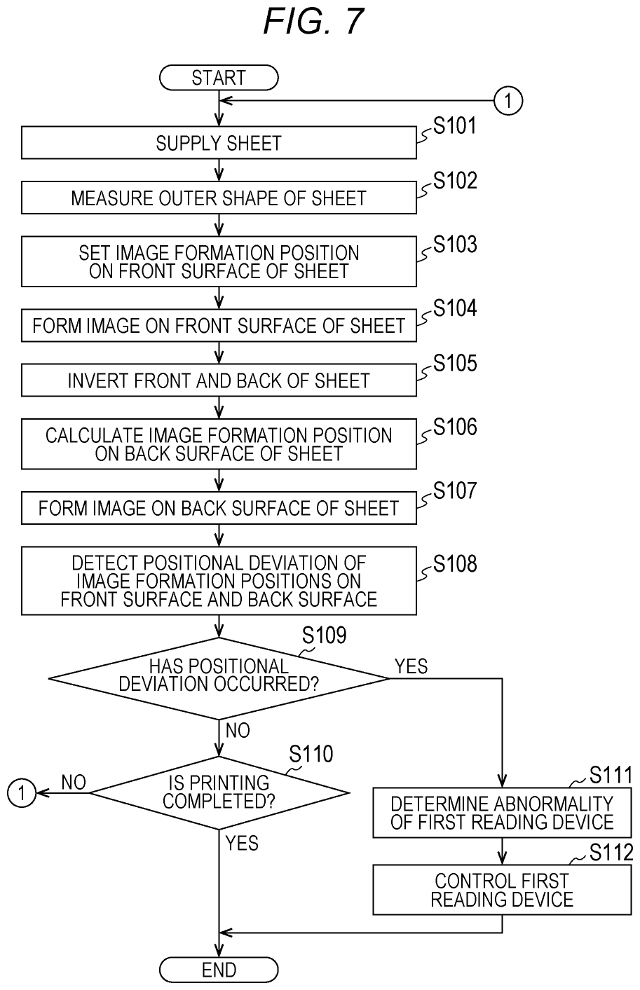

Hereinafter, a method of controlling the image forming system 30 will be described. FIG. 7 is a flowchart exemplifying a processing procedure of a method of controlling the image forming system 30 according to the first embodiment. The processing in the flowchart illustrated in the drawing is implemented by the controller 380 and the controllers of the first reading device 200 and the second reading device 400 executing a control program and cooperating with each other.

First, the sheet feed device 100 supplies the sheet S (step S101). In response to a print instruction from the user, the controller 380 instructs the controller 140 to feed a sheet to the first reading device 200. The controller 140 supplies the sheet S to the first reading device 200 in response to the instruction of the controller 380.

Next, the first reading device 200 measures the outer shape of the sheet S (step S102). The upper scanner 221 scans and reads a range wider than the width of the sheet S on the front surface in the main scanning direction while the sheet S is being conveyed on the sheet conveyance path by the sheet conveyor 210. The first reading device 200 detects the leading end and the trailing end of the sheet S, and calculates the length MPL of the sheet based on the difference between the detection timings of the leading end and the trailing end of the sheet and the sheet conveyance speed.

Next, the controller 380 sets the image formation position on the front surface of the sheet S (step S103). The controller 380 reads the first adjustment value from the auxiliary storage device 382, and sets the image formation position on the front surface of the sheet S to a position (for example, the front-back alignment position P) separated from the leading end (E1) of the sheet S by the first adjustment value.

Next, the controller 380 forms an image on the front surface of the sheet S (step S104). The controller 380 controls the image former 320 to form an image including the register marks on the front surface of the sheet S from a position separated from the leading end (E1) of the sheet S by the first adjustment value.

Next, the controller 380 inverts the front and back of the sheet S (step S105). The controller 380 causes the sheet inverter of the sheet conveyor 340 to invert the front and back of the sheet S in the image forming apparatus 300.

Next, the controller 380 sets an image formation position on the back surface of the sheet S (step S106). Specifically, based on the length MPL of the sheet S calculated in step S102, the controller 380 calculates the image formation position on the back surface of the sheet S corrected so that the positions of the register marks on the front surface and the back surface of the sheet S are aligned. Specifically, the controller 380 calculates the second adjustment value (=MPL−(first adjustment value+IL)) for the sheet S and sets, as the image formation position on the back surface, a position separated from the leading end (E2) of the sheet S at the time of image formation on the back surface by the second adjustment value+IL.

Next, the controller 380 forms an image on the back surface of the sheet S (step S107). The controller 380 controls the image former 320 to form, on the back surface of the sheet S, an image including register marks from a position separated from the leading end (E2) of the sheet S by the second adjustment value to the image formation position on the back surface.

Next, the second reading device 400 detects a positional deviation of the image formation positions on the front surface and the back surface (step S108). The second reading device 400 reads the register marks on both the front surface and the back surface of the sheet S by the upper scanner 421 and the lower scanner 431. The second reading device 400 functions as a determiner, and when the positions of the register marks on both the front surface and the back surface corresponding to the front-back alignment positions P coincide with each other as a result of the reading, the second reading device 400 determines that no deviation occurs between the position of the image formation position on the front surface and the position of the image formation position on the back surface. On the other hand, when the positions of the register marks on the front surface and the back surface do not coincide with each other as a result of the reading, the determiner determines that a deviation occurs between the position of the image formation position on the front surface and the position of the image formation position on the back surface.

Next, when a positional deviation has not occurred (step S109: NO), the controller 380 determines whether printing is completed (step S110). When the printing is completed (step S110: YES), the controller 380 ends the processing (END). On the other hand, when the printing is not completed (step S110: NO), the controller 380 returns to the processing of step S101.

On the other hand, when a positional deviation has occurred (step S109: YES), there is a possibility that an abnormality occurs in at least one of the first reading device 200 or the second reading device 400. When it is known that no abnormality has occurred in the second reading device 400, the determiner determines that a cause of the occurrence of the positional deviation is due to an abnormality of the first reading device 200. Next, the determiner determines the abnormality of the first reading device 200 (the upper scanner 221 and/or the lower scanner 231) (step S111). In this way, the determiner determines the abnormality of the first reading device 200 depending on whether the positions of the register marks on the front surface and the back surface corresponding to the front-back alignment position P of the sheet S coincide with each other. Alternatively, the determiner determines the abnormality of the first reading device 200 based on the length MPL (size) of the sheet S and a distance (for example, the second adjustment value) from the end (E2) of the sheet S in the sheet conveyance direction to the formed image. The length MPL of the sheet S is based on a reading result of the upper scanner 221. The distance is based on each reading result of the lower scanner 431.

Next, the second reading device 400 controls the first reading device 200 (step S112). The second reading device 400 causes the first reading device 200 to read a proof sheet in the following case to confirm the presence or absence of abnormality of the first reading device 200 and perform calibration. The case is a case where it is not possible to determine which of the first reading device 200 or the second reading device 400 has an abnormality or a case where it is determined that the first reading device 200 has an abnormality. Specifically, the second reading device 400 requests the controller 380 to feed a proof sheet for calibrating the measurement of the size of the sheet by the first reading device 200, and the first reading device 200 reads the proof sheet and confirms whether the reading is correctly performed. When the reading of the first reading device 200 is not correctly performed, the second reading device 400 can control the first reading device 200 to correct the size of the sheet. The proof sheet is a sheet whose accurate size is known in advance by measurement. Therefore, by causing the first reading device 200 to read the proof sheet, the second reading device 400 can determine the presence or absence of an abnormality in the first reading device 200 when it cannot be determined which of the first reading device 200 or the second reading device 400 has an abnormality. The calibration of the first reading device 200 is preferably minimized from the viewpoint of maintaining productivity.

Note that a possible reason why the length of the sheet cannot be accurately measured in the first reading device 200 is, for example, that the background applied when the sheet is read is not appropriate. Therefore, the second reading device 400 can be controlled to rotate the first background member 222 or the second background member 232 with respect to the first reading device 200 so as to obtain an appropriate background.

Another possible reason why the length of the sheet cannot be accurately measured is, for example, that a parameter used by the first reading device 200 for reading the sheet is not appropriate. Examples of the parameter include white balance, a black level, and a white level. For example, the second reading device 400 can request the controller 380 to feed a proof sheet for calibrating white and control the first reading device 200 to correct white balance.

As described above, in the processing of the flowchart illustrated in FIG. 7, after supplying the sheet S, the image forming system 30 measures the outer shape of the sheet S, calculates the image formation position on the front surface of the sheet S, and forms an image on the front surface of the sheet S. Subsequently, after inverting the front and back of the sheet S, the image forming system 30 calculates the image formation position on the back surface of the sheet S and forms an image on the back surface of the sheet S. Then, when the image forming system 30 detects a positional deviation between the image formation position on the front surface and the image formation position on the back surface, and the positional deviation occurs, the image forming system 30 determines an abnormality of the first reading device 200 and controls the first reading device 200.

The image forming system 30 of the present embodiment described above can achieve the following effects.

Since the image forming system 30 determines the abnormality of the first reading device 200 and controls the first reading device 200, it is possible to suppress an increase in downtime due to complication of the configuration of the image forming system 30.

### Second Embodiment

In a second embodiment, a case will be described where the first reading device 200 further includes a detector that detects a moisture percentage of a sheet. In the second embodiment, when a toner image is fixed to a sheet in the image forming apparatus 300, an expected value (expected shrinkage value) of a length by which the sheet shrinks in accordance with the moisture percentage of the sheet is calculated, and a second adjustment value is calculated in consideration of the expected shrinkage value. In order to avoid redundant description, the same configuration as in the first embodiment will not be described in detail.

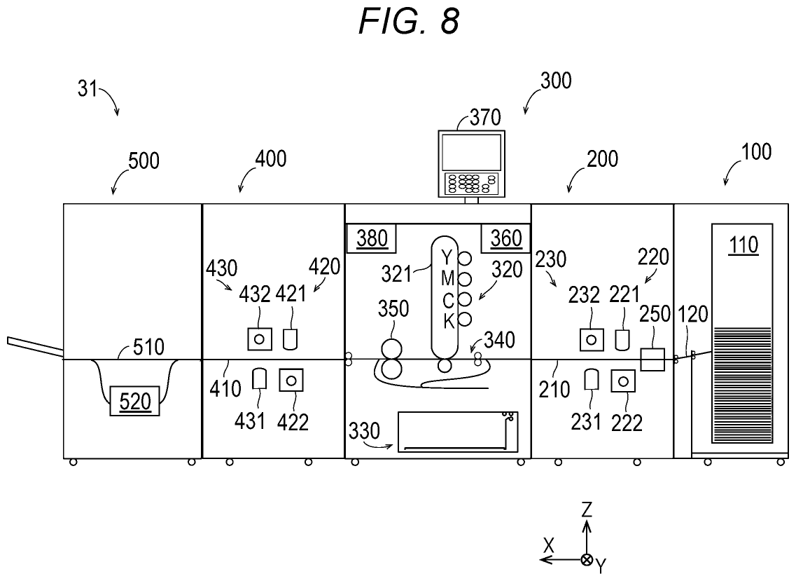

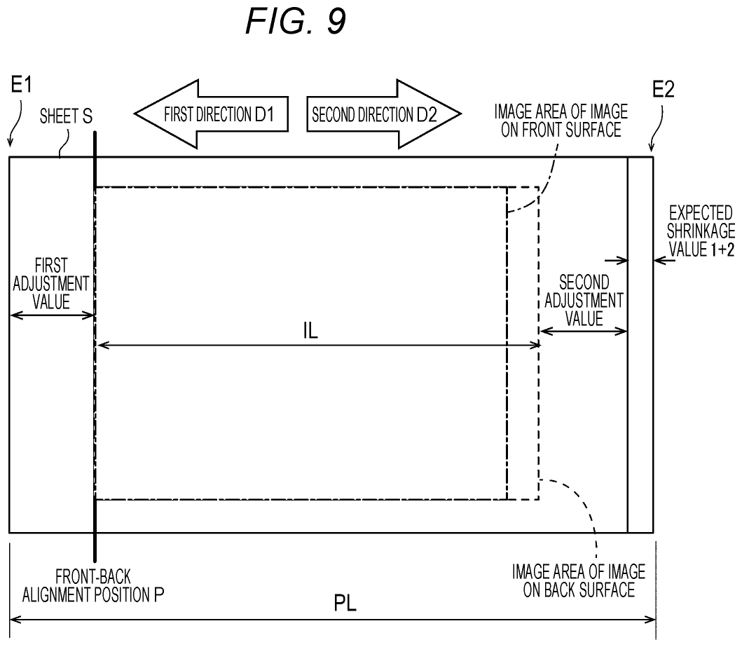

FIG. 8 is a schematic block diagram of a printing system 31 according to the second embodiment of the present invention, and FIG. 9 is a conceptual diagram for describing a feedforward front-back alignment control of a sheet in the second embodiment. In the first reading device 200, a detector 250 measures the moisture percentage (a physical property value related to an amount of moisture, and also referred to as a water content) of the sheet S (a sheet on which no image is formed) conveyed on the sheet conveyance path. The detector 250 includes an optical sensor, a calculator, and a storage (none of which are illustrated). The optical sensor includes a light emitting element, a light receiving element, and optical elements such as a lens, an aperture, and a collimating lens, and irradiates the sheet S with light having a predetermined wavelength in a near-infrared region from the light emitting element and detects a reflected light by the light receiving element. The calculator estimates the moisture percentage of the sheet S by utilizing a property in which an absorptance of light having a predetermined wavelength in the near-infrared region changes in accordance with the moisture percentage of the sheet S. Specifically, the calculator calculates or acquires, for the sheet S, the moisture percentage corresponding to the measured absorptance based on a formula or a table representing a relation between the absorptance of light having a predetermined wavelength in the near-infrared region and the moisture percentage. The formula or the table is stored in the storage in advance, for example.

In the image forming apparatus 300, when the sheet S is heated by the fixer 350, the sheet S shrinks in accordance with the moisture contained in the sheet S. In a case where both surfaces of the sheet S are fixed, the sheet S shrinks when the toner image formed on the front surface is fixed and further shrinks when the toner image formed on the back surface is fixed. As illustrated in FIG. 9, when an expected shrinkage value due to fixing of the front surface is an expected shrinkage value 1 and an expected shrinkage value due to fixing of the back surface is an expected shrinkage value 2, the expected shrinkage value due to the fixing of the front surface and the back surface is a value obtained by summing the expected shrinkage value 1 and the expected shrinkage value 2.

The controller 380 calculates (acquires) an expected shrinkage value corresponding to the measured moisture percentage (detection result) based on a formula or a table representing the relation between the moisture percentage of the sheet S and the expected shrinkage value of the sheet S due to fixing. The formula or the table is stored in the auxiliary storage device 382 in advance, for example. When an image is formed on the back surface of the sheet S, it is estimated that the sheet S has already shrunk by the expected shrinkage value 1 due to fixing of the front surface. Therefore, the controller 380 calculates the second adjustment value (=MPL−(the first adjustment value+IL+the shrinkage expected value 1 of the front surface)) in consideration of the expected shrinkage value 1, and sets a position separated from the leading end (E2) of the sheet by (the second adjustment value+IL+the expected shrinkage value 1 of the front surface) as the image formation position.

### <Method of Controlling Image Forming System 30>

As in the first embodiment, as long as the length PL of the sheet S is measured accurately by the first reading device 200, the image formation positions on the front and back always coincide with each other by the feedforward front-back alignment control. However, when an error occurs in the expected shrinkage value calculated (acquired) from the moisture percentage of the sheet S, a deviation can occur in the image formation positions on the front and back. It is therefore possible to detect an abnormality (including a failure) of the first reading device 200 (the upper scanner 211 or the lower scanner 231) based on whether the image formation positions on the front and back coincide with each other. As in the first embodiment, whether the image formation positions on the front and back coincide with each other can be determined by using the register marks for positional deviation detection.

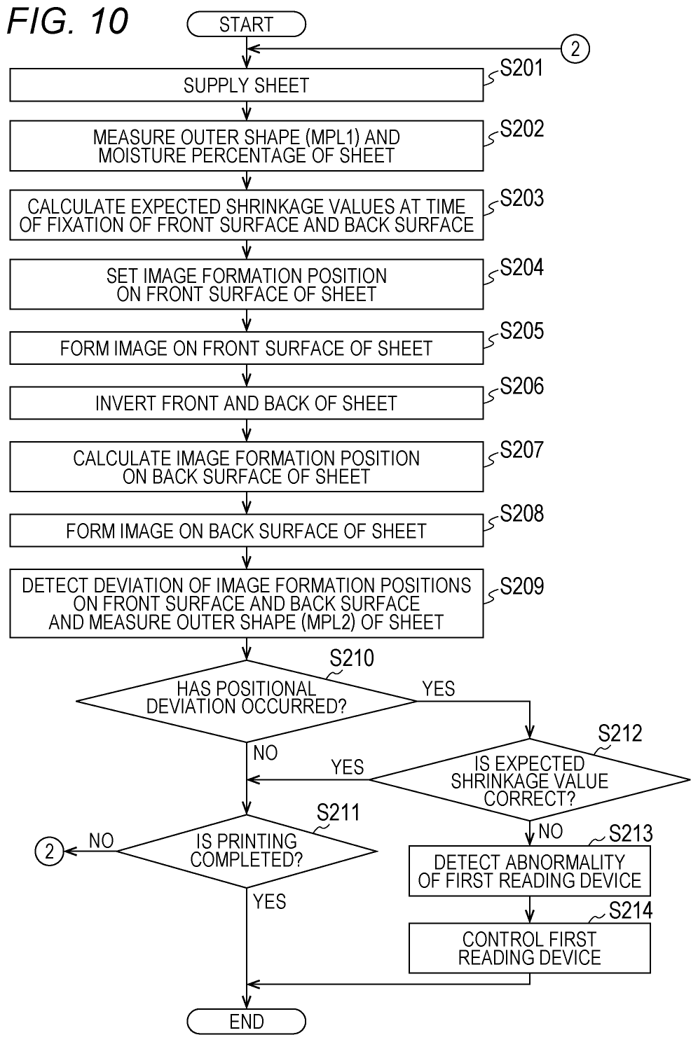

Hereinafter, a method of controlling the image forming system 30 of the present embodiment will be described. FIG. 10 is a flowchart exemplifying a processing procedure of a method of controlling the image forming system 30 illustrated in FIG. 8. The processing in the flowchart illustrated in the drawing is implemented by the controller 380 and the controllers of the first reading device 200 and the second reading device 400 executing a control program and cooperating with each other.

First, the sheet feed device 100 supplies the sheet S (step S201). In response to a print instruction from the user, the controller 380 instructs the controller 140 to feed a sheet to the first reading device 200. The controller 140 supplies the sheet S to the first reading device 200 in response to the instruction of the controller 380.

Next, the first reading device 200 measures the outer shape and the moisture percentage of the sheet S (step S202). For example, the upper scanner 221 calculates the length MPL1 of the sheet S based on the difference between the detection timings of the leading end and the trailing end of the sheet S and the sheet conveyance speed. The detector 250 calculates the absorptance of the sheet S and acquires the moisture percentage of the sheet S from the relationship between the absorptance and the moisture percentage represented by a formula or a table.

Next, the controller 380 calculates each of the expected shrinkage values 1 and 2 during at the time of fixing the front surface and the back surface (step S203). The controller 380 calculates the expected shrinkage values 1 and 2 at the time of fixing of the front surface and the back surface, respectively, from the relationship between the moisture percentage and the expected shrinkage value represented by a formula or a table based on the moisture percentage of the sheet S calculated in step S202.

Next, the controller 380 sets an image formation position on the front surface of the sheet S (step S204). The controller 380 reads the first adjustment value from the auxiliary storage device 382, and sets the image formation position on the front surface of the sheet S to a position separated from the leading end of the sheet S by the first adjustment value (for example, the front-back alignment position P).

Next, the controller 380 forms an image on the front surface of the sheet S (step S205). The controller 380 controls the image former 320 to form an image including the register marks on the front surface of the sheet S from a position separated from the leading end (E1) of the sheet S by the first adjustment value.

Next, the controller 380 inverts the front and back of the sheet S (step S206). The controller 380 causes the sheet inverter of the sheet conveyor 340 to invert the front and back of the sheet S in the image forming apparatus 300.

Next, the controller 380 sets an image formation position on the back surface of the sheet S (step S207). Specifically, the controller 380 calculates, based on the length MPL1 of the sheet S calculated in step S202, the image formation positions on the back surface of the sheet S corrected so that the positions of the register marks on the front and back of the sheet S are aligned. More specifically, the controller 380 calculates the second adjustment value (=MPL1−(the first adjustment value+IL+the expected shrinkage value 1 of the front surface)) for the sheet S. The controller 380 sets, as the image formation position on the back surface, a position separated from the leading end (E2) of the sheet S at the time of the image formation on the back surface by (the second adjustment value+IL+the expected shrinkage value 1 of the front surface).

Next, the controller 380 forms an image on the back surface of the sheet (step S208). The controller 380 controls the image former 320 to form, on the back surface of the sheet S, an image including register marks from a position separated from the leading end (E2) of the sheet S by the second adjustment value to the image formation position on the back surface.

Next, the second reading device 400 detects a deviation of the image formation positions on the front surface and the back surface, and measures the outer shape of the sheet S (step S209). The second reading device 400 reads the register marks on both the front surface and the back surface of the sheet S by the upper scanner 421 and the lower scanner 431. The second reading device 400 functions as a determiner, and determines that no deviation occurs between the position of the image formation position on the front surface and the position of the image formation position on the back surface when the positions of the register marks corresponding to the front-back alignment positions P on both the front surface and the back surface coincide with each other as a result of reading. On the other hand, when the positions of the register marks corresponding to the front-back alignment positions P on both the front surface and the back surface do not coincide with each other as a result of the reading, the determiner determines that a deviation occurs between the position of the image formation position on the front surface and the position of the image formation position on the back surface. The second reading device 400 measures the outer shape of the sheet S. For example, the upper scanner 421 calculates the length MPL2 of the sheet S based on the difference between the detection timings of the leading end and the trailing end of the sheet S and the sheet conveyance speed.

Next, when a positional deviation has not occurred (step S210: NO), the controller 380 determines whether the printing is completed (step S211). When the printing is completed (step S211: YES), the controller 380 ends the processing (END). On the other hand, when the printing is not completed (step S211: NO), the controller 380 returns to the processing of step S201.

On the other hand, when a positional deviation has occurred (step S210: YES), the controller 380 determines whether the expected shrinkage value is correct (step S212). The second reading device 400 determines whether the expected shrinkage value is correct based on whether a difference DL between the length MPL1 of the sheet S before image formation and the length MPL2 of the sheet S after image formation on both surfaces is equal to a total value TS of the expected shrinkage value 1 and the expected shrinkage value 2. The second reading device 400 determines that the expected shrinkage value is correct when the difference DL is substantially equal to the total value TS, and determines that the expected shrinkage value is not correct when the difference DL is not equal to the total value TS. When the expected shrinkage value is correct (step S212: YES), the processing proceeds to step S211. On the other hand, when the expected shrinkage value is not correct (step S212: NO), there is a possibility that an abnormality has occurred in at least one of the first reading device 200 or the second reading device 400. The second reading device 400 functions as a determiner, and when it is known that no abnormality has occurred in the second reading device 400, the second reading device 400 determines the cause of the occurrence of the positional deviation is due to an abnormality of the first reading device 200 and determines the abnormality of the first reading device 200 (step S213).

Next, the second reading device 400 controls the first reading device 200 (step S214). The control of the first reading device 200, which is similar to the control in the first embodiment, will not be described in detail.

As described above, in the processing of the flowchart illustrated in FIG. 10, after supplying the sheet S, the image forming system 30 measures the outer shape and the moisture percentage of the sheet S, and calculates the expected shrinkage values at the time of fixing of the front surface and the back surface. Next, the image forming system 30 calculates an image formation position on the front surface of the sheet S, forms an image on the front surface of the sheet S, inverts the front and back of the sheet, calculates an image formation position on the back surface of the sheet S, and forms an image on the back surface of the sheet S. Then, the image forming system 30 detects a positional deviation between the image formation position on the front surface and the image formation position on the back surface, and when the positional deviation occurs and the expected shrinkage value is not correct, the image forming system 30 determines the abnormality of the first reading device and controls the first reading device 200.

The image forming system 30 of the present embodiment described above can achieve the following effects in addition to the effects of the first embodiment.

Since the second adjustment value is calculated in consideration of the expected shrinkage value of the sheet S due to the fixing and the abnormality of the first reading device 200 is determined, it is possible to improve accuracy of abnormality determination of the first reading device 200.

### Third Embodiment

In the first and second embodiments, a case has been described where an abnormality in the first reading device 200 is determined. In a third embodiment, a case will be described where an abnormality in the second reading device 400 is determined. In the third embodiment, the lengths of the sheet before and after the image formation are measured by the first reading device 200 and the second reading device 400, respectively. Then, an abnormality in the second reading device 400 is determined based on whether the length of the sheet after image formation that has shrunk due to heating for fixing is shorter than the length of the sheet before image formation. In order to avoid redundant description, the same configuration as in the first embodiment will not be described in detail.

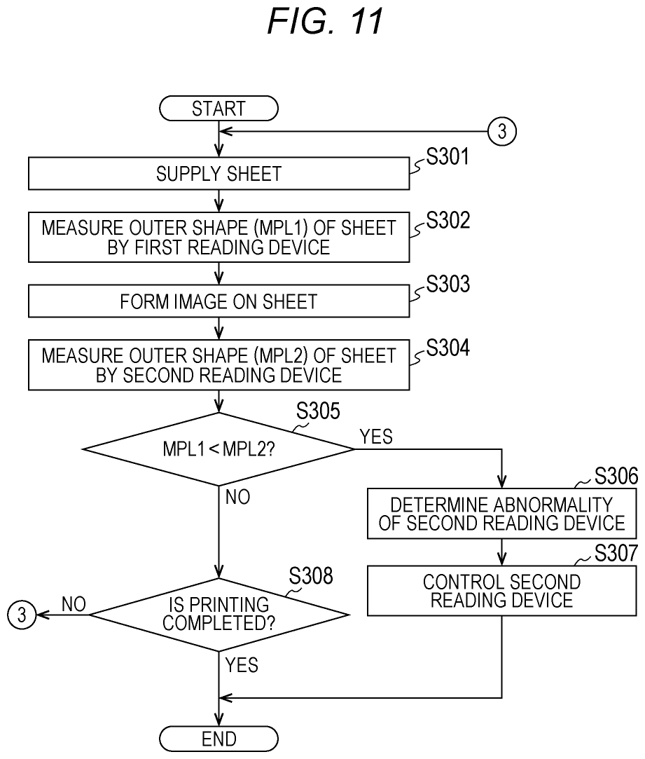

FIG. 11 is a flowchart exemplifying a processing procedure of a method of controlling the image forming system 30 according to the third embodiment. The processing in the flowchart illustrated in the drawing is implemented by the controller 380 and the controllers of the first reading device 200 and the second reading device 400 executing a control program and cooperating with each other.

First, the sheet feed device 100 supplies the sheet S (step S301). In response to a print instruction from the user, the controller 380 instructs the controller 140 to feed a sheet to the first reading device 200. The controller 140 supplies the sheet S to the first reading device 200 in response to the instruction of the controller 380.

Next, the first reading device 200 measures the outer shape of the sheet S (step S302). For example, the upper scanner 221 calculates the length MPL1 of the sheet S based on the difference between the detection timings of the leading end and the trailing end of the sheet S and the sheet conveyance speed.

Next, the controller 380 forms an image on the sheet S (step S303). The controller 380 causes the image forming apparatus 300 to form, for example, a predetermined image on the front surface of the sheet S.

Next, the second reading device 400 measures the outer shape of the sheet S (step S304). For example, the upper scanner 421 calculates the length MPL2 of the sheet S based on the difference between the detection timings of the leading end and the trailing end of the sheet S and the sheet conveyance speed. Note that after the length MPL1 of the sheet S is measured by the first reading device 200, the length MPL2 of the sheet S is measured again by the second reading device 400, and thus, the length MPL2 of the sheet S after shrinkage can be reflected in conveyance control. As a result, the second reading device 400 can implement accurate control of conveyance of the sheet S to the post-processing device 500. The second reading device 400 transmits the measured length MPL2 of the sheets S to the first reading device 200.

Next, the first reading device 200 compares the lengths MPL1 and MPL2 of the sheet S (step S305). The upper scanner 221 functions as a determiner, and when MPL1<MPL2 (step S305: YES), the upper scanner 221 determines an abnormality of the second reading device 400 (step S306). Since the sheet S is estimated to have shrunk by the expected shrinkage value 1 due to fixing of the front surface, when the second reading device 400 is normal, it is assumed that MPL1>MPL2, comparing the lengths MPL1 and MPL2 of the sheet S. Therefore, when MPL1<MPL2, it is considered that an abnormality has occurred at least in the second reading device 400.

Next, the second reading device is controlled (step S307). As a reason why the length of the sheet S cannot be accurately measured in the second reading device 400, for example, it is considered that a background applied when the sheet S is read is not appropriate. Therefore, the first reading device 200 can be controlled to rotate the first background member 422 and/or the second background member 432 with respect to the second reading device 400 so as to obtain an appropriate background.

Another possible reason why the length of the sheet S cannot be accurately measured is, for example, that a parameter used by the second reading device 400 for reading the sheet S is not appropriate. Examples of the parameter include white balance, a black level, and a white level. For example, the first reading device 200 can request the controller 380 to feed a proof sheet for calibrating white and control the second reading device 400 to correct white balance.

On the other hand, when MPL1<MPL2, that is, MPL1≥MPL2 (step S305: NO), the second reading device 400 is normal. The controller 380 determines whether the printing is completed (step S308). When the printing is completed (step S308: YES), the controller 380 ends the processing (END). On the other hand, when the printing is not completed (step S308: NO), the controller 380 returns to the processing of step S301.

As described above, in the processing of the flowchart illustrated in FIG. 11, the image forming system 30 measures the length MPL1 of the sheets S by the first reading device 200 after supplying the sheets S to the first reading device 200, and measures the length MPL2 of the sheet S by the second reading device 400 after forming an image on the sheet S. Then, the image forming system 30 compares the MPL1 with the MPL2, and when the MPL2 is larger than the MPL1, the image forming system 30 determines that an abnormality has occurred in the second reading device 400 and controls the second reading device 400.

The image forming system 30 of the present embodiment described above can achieve the following effects in addition to the effects of the first embodiment and the second embodiment.

Since the image forming system 30 determines the abnormality of the second reading device 400 and controls the second reading device 400, it is possible to further suppress an increase in downtime due to complication of the configuration of the image forming system 30.

When it is determined that an abnormality has occurred in at least one of the first reading device 200 or the second reading device 400 in the first or second embodiment, and it is not determined that an abnormality has occurred in the second reading device 400 in the third embodiment, the abnormality in the first reading device 200 can be confirmed. By combining the first or second embodiment with the third embodiment, it is also possible to determine an abnormality when there is an abnormality in both the first reading device 200 and the second reading device 400. The first reading device 200 and the second reading device 400 can control each other based on the respective reading results.

### Fourth Embodiment

In a fourth embodiment, a case will be described where the abnormality of the first reading device 200 is determined based on a comparison result between the composite image and the formed image. The composite image is an image obtained by adding an image to be formed on a sheet (image to be formed) to a read image (blank image) of a sheet (blank sheet) on which no image is formed. The formed image is a read image of an image formed on a sheet based on the image to be formed. That is, when no abnormality has occurred in the first reading device 200, it is considered that the composite image substantially coincides with the formed image and there is no large difference between the two images. On the other hand, when there is an abnormality in the first reading device 200, a difference can be generated between the composite image and the formed image, and thus it is possible to determine the abnormality of the first reading device 200 based on the difference. In order to avoid redundant description, the same configuration as in the first embodiment will not be described in detail.

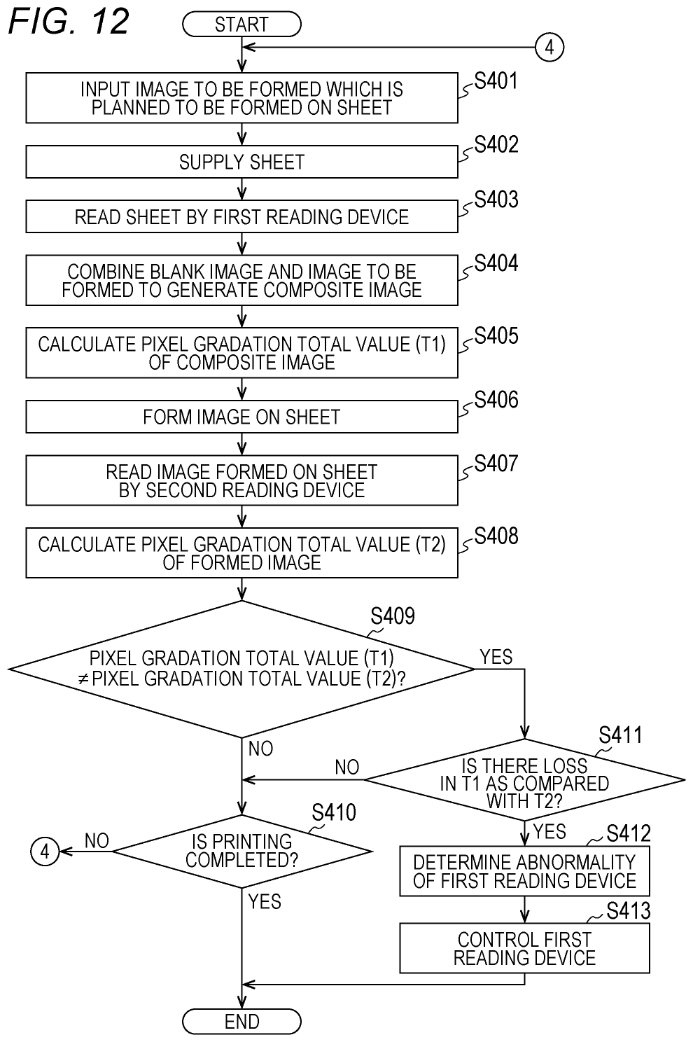

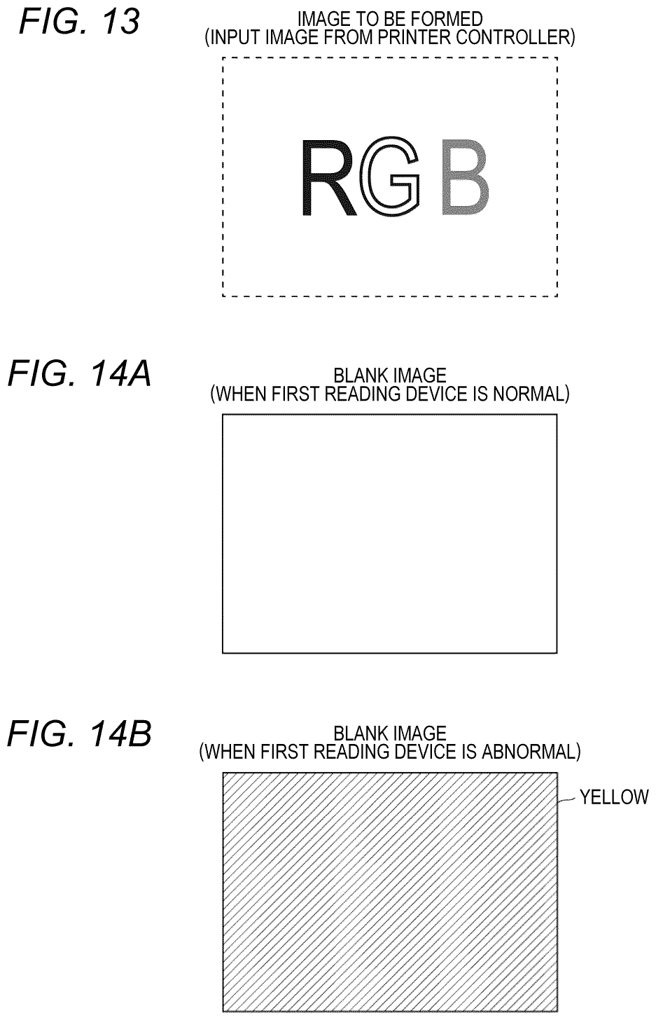

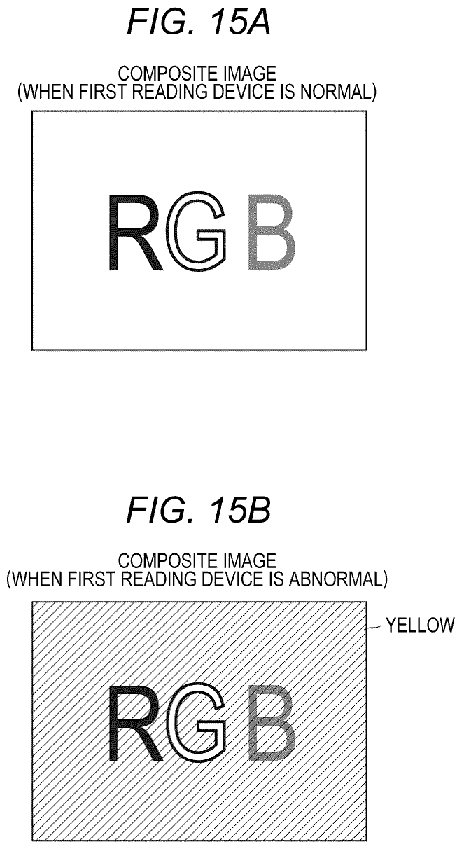

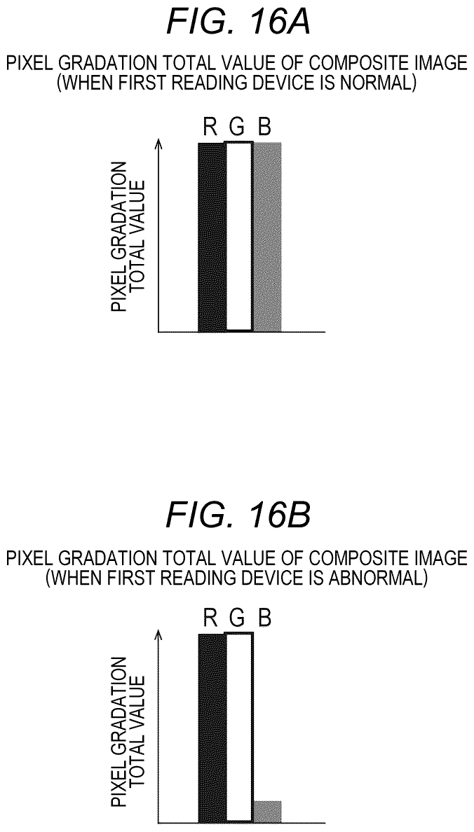

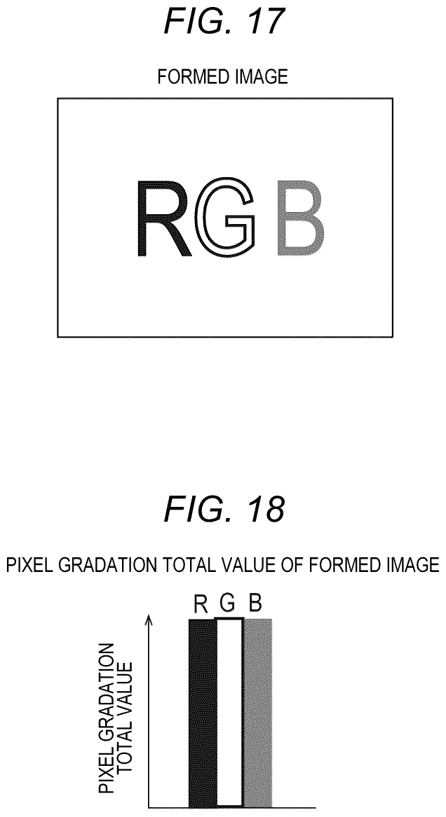

FIG. 12 is a flowchart exemplifying a processing procedure of a method of controlling the image forming system 30 according to the fourth embodiment. The processing in the flowchart illustrated in the drawing is implemented by the controller 380 and the controllers of the first reading device 200 and the second reading device 400 executing a control program and cooperating with each other. FIG. 13 is a schematic diagram exemplifying an image to be formed, FIG. 14A is a schematic diagram exemplifying a blank image when the first reading device 200 is normal, and FIG. 14B is a schematic diagram exemplifying a blank image when the first reading device 200 is abnormal. FIG. 15A is a schematic diagram exemplifying a composite image when the first reading device 200 is normal, and FIG. 15B is a schematic diagram exemplifying a composite image when the first reading device 200 is abnormal. FIG. 16A is a schematic diagram exemplifying the pixel gradation total value of a composite image when the first reading device 200 is normal, and FIG. 16B is a schematic diagram exemplifying the pixel gradation total value of a composite image when the first reading device 200 is abnormal. FIG. 17 is a schematic diagram exemplifying a formed image, and FIG. 18 is a schematic diagram exemplifying a pixel gradation total value of the formed image.

As illustrated in FIG. 12, first, the image forming apparatus 300 inputs an image to be formed on a sheet S (step S401). As illustrated in FIG. 13, the image forming apparatus 300 receives the input of an image to be formed from, for example, the printer controller 20. As an example, the image to be formed includes a character (R) in red, a character (G) in green, and a character (B) in blue. In FIG. 13, for convenience of illustration, red is replaced with black, green is replaced with white, and blue is replaced with gray.

Next, the sheet feed device 100 supplies the sheet S (step S402). The controller 140 supplies the sheet S to the first reading device 200 in response to the instruction of the controller 380.

Next, the first reading device 200 reads the sheet S (step S403). For example, the upper scanner 221 generates a blank image by reading the front surface of the sheet S on which no image is formed. As illustrated in FIG. 14A, for example, when each pixel in the image includes 8-bit×three primary colors (RGB) and the upper scanner 221 is normal, the following is assumed. Pixel values of all the pixels in the generated blank image are close to 255 (maximum value) for each of the RGB colors.

On the other hand, it is assumed that an abnormality has occurred in reading of, for example, blue (B) among RGB in the upper scanner 221. In this case, for example, it is assumed that both colors of red (R) and green (G) of each pixel have a value close to 255 (maximum value) over the entire blank image, but blue (B) has 0 (minimum value). As a result, as illustrated in FIG. 14B, the blank image has a color close to yellow as a whole.

Next, the first reading device 200 (for example, the upper scanner 221) combines the blank image and the image to be formed to generate a composite image (step S404). As illustrated in FIG. 15A, when the upper scanner 221 is normal, pixel values of a portion of the composite image excluding the image to be formed have values close to 255 (maximum value) for each of the RGB colors. On the other hand, as illustrated in FIG. 15B, when an abnormality has occurred in the reading of blue (B) by the upper scanner 221, the pixel values of the portion of the composite image excluding the image to be formed have values close to 255 (maximum value) for both of the RG colors, and 0 (minimum value) for B.

Next, the first reading device 200 calculates the pixel gradation total value (T1) for the composite image (step S405). For example, the upper scanner 221 of the first reading device 200 calculates the pixel gradation total value (T1) for each color by summing the pixel values of all the pixels for each of the RGB colors of the composite image. The first reading device 200 transmits the calculated pixel gradation total value (T1) to the second reading device 400.

As described above, the composite image is an image obtained by combining the blank image and the image to be formed. When the upper scanner 221 is normal, the pixel values of all the pixels of RGB of the blank image are close to 255. Therefore, as illustrated in FIG. 16A, when a difference between the pixel gradation total values of RGB of the image to be formed is small, a difference between the pixel gradation total values (T1) of RGB of the composite image is also small.

On the other hand, as illustrated in FIG. 16B, when an abnormality has occurred in the reading of blue (B) by the upper scanner 221, B of each pixel of the blank image is missing, and thus the pixel gradation total value for B is significantly smaller than the pixel gradation total values for red (R) and green (G).

Next, the image forming apparatus 300 forms an image on the sheet S (step S406). The controller 380 performs control so as to form an image on the front surface of the sheet S based on the image to be formed.

Next, the second reading device 400 reads the image formed on the sheet S (step S407). For example, as illustrated in FIG. 17, the upper scanner 421 generates a formed image by reading the image formed on the front surface of the sheet S.

Next, the second reading device 400 calculates the pixel gradation total value (T2) for the formed image (step S408). For example, the upper scanner 421 of the second reading device 400 calculates the pixel gradation total value (T2) for each color by summing the pixel values of all the pixels for each of the RGB colors of the formed image.

Next, the second reading device 400 compares the pixel gradation total value (T1) and the pixel gradation total value (T2), and determines whether the two values (the pixel gradation total value (T1) and the pixel gradation total value (T2)) are different (step S409). The second reading device 400 determines whether the two values are different, for example, by determining whether the difference between the two values is greater than or equal to a predetermined threshold value. When the difference is greater than or equal to the threshold value, it is determined that the two values are different, and when the difference is less than the threshold value, it is determined that the two values are not different, that is, the two values are the same.

When the pixel gradation total value (T1) and the pixel gradation total value (T2) are the same (step S409: NO), the second reading device 400 determines whether the printing is completed (step S410). When the printing is completed (step S410: YES), the controller 380 ends the processing (END). On the other hand, when the printing is not completed (step S410: NO), the controller 380 returns to the processing of step S401.

On the other hand, when the pixel gradation total value (T1) and the pixel gradation total value (T2) are different (step S409: YES), the second reading device 400 compares (T2) with (T1) and determines whether there is a loss in (T1) (S411). The second reading device 400 proceeds to the processing of step S410 when there is no loss in (T1) as compared with (T2) (step S411: NO). On the other hand, the second reading device 400 functions as a determiner, and when there is a loss in (T2) as compared with (T1) (step S411: YES), the second reading device 400 determines an abnormality of the first reading device 200 (step S412). For example, when an abnormality has occurred in the reading of blue (B) by the upper scanner 221, B is missing from each pixel of the blank image, and therefore the pixel gradation total value for B is significantly smaller than the pixel gradation total values for the red (R) and the green (G). Accordingly, the second reading device 400 can determine an abnormality of the first reading device 200 (the upper scanner 221). In this way, since the second reading device 400 determines the presence or absence of a loss in (T2) with reference to (T1), the second reading device 400 can determine an abnormality of the first reading device 200 regardless of the presence or absence of an abnormality of the second reading device 400.

Next, the first reading device 200 is controlled (step S413). The control of the first reading device 200, which is similar to the control in the first embodiment, will not be described in detail.

As described above, in the processing of the flowchart illustrated in FIG. 12, the image forming system 30 inputs an image to be formed which is planned to be formed on the sheet S, supplies the sheet S, reads the sheet S, generates a composite image, and calculates the pixel gradation total value (T1) for the composite image. Subsequently, the image forming system 30 forms an image on the sheet S, reads the image formed on the sheet S, and calculates the pixel gradation total value (T2) for the formed image. Next, the image forming system 30 compares the pixel gradation total value (T1) with the pixel gradation total value (T2), and determines that an abnormality has occurred in the first reading device 200 when the two values are different from each other.

The image forming system 30 of the present embodiment described above can achieve the following effects in addition to the effects of the first embodiment.

Even when an abnormality occurs in reading of one or more colors in the first reading device 200, an abnormality can be determined.

### Fifth Embodiment

In the fourth embodiment, a case has been described where the abnormality of the first reading device 200 is determined based on the comparison result between the composite image and the formed image. In a fifth embodiment, a case will be described where the abnormality of the second reading device 400 is determined based on the comparison result between the composite image and the formed image. That is, when no abnormality has occurred in the second reading device 400, it is considered that the composite image substantially coincides with the formed image and there is no large difference between the two images. On the other hand, when there is an abnormality in the second reading device 400, a difference can be generated between the composite image and the formed image, and thus it is possible to determine the abnormality of the second reading device 400 based on the difference. In order to avoid redundant description, the same configuration as in the first embodiment will not be described in detail.

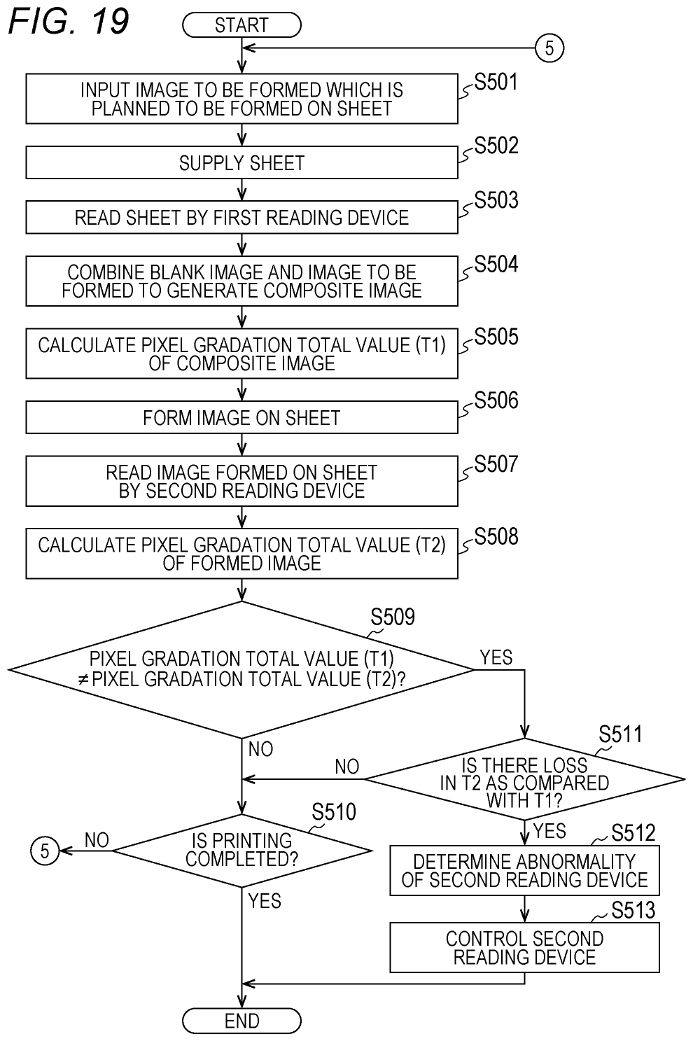

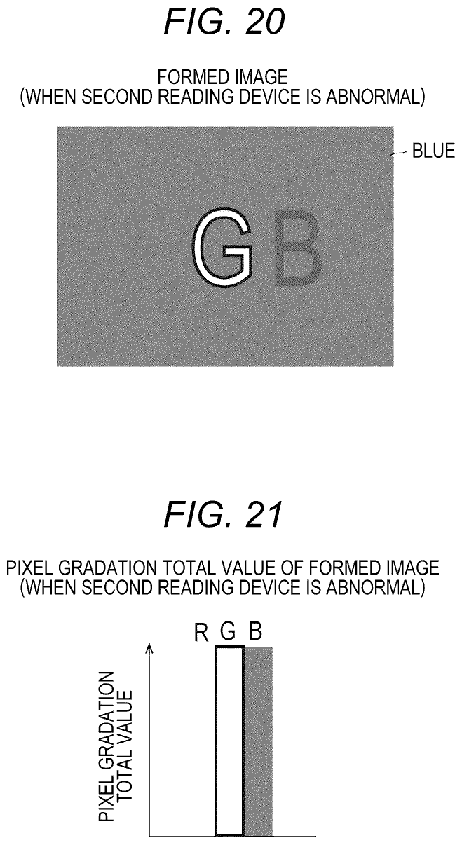

FIG. 19 is a flowchart exemplifying a processing procedure of a method of controlling the image forming system 30 in the fifth embodiment. The processing in the flowchart illustrated in the drawing is implemented by the controller 380 and the controllers of the first reading device 200 and the second reading device 400 executing a control program and cooperating with each other. FIG. 20 is a schematic diagram exemplifying a formed image when the second reading device 400 is abnormal, and FIG. 21 is a schematic diagram exemplifying a pixel gradation total value of a formed image when the second reading device 400 is abnormal.

The processing of steps S501 to S510 of FIG. 19, which is the same as the processing of steps S401 to S410 of FIG. 12 in the fourth embodiment, will not be described in detail.

In step S511; it is determined whether there is a loss in (T1) as compared with (T2). When there is no loss in (T1) as compared with (T2) (step S511: NO), the first reading device 200 proceeds to the processing of step S510. On the other hand, the first reading device 200 functions as a determiner, and when there is a loss in (T1) as compared with (T2) (step S511: YES), the first reading device 200 determines an abnormality of the second reading device 400 (step S512). As illustrated in FIGS. 20 and 21, for example, when an abnormality has occurred in the reading of red (R) by the upper scanner 421, R of each pixel of the formed image is missing. Therefore, the pixel gradation total value for R is significantly smaller than the pixel gradation total values for green (G) and blue (B). Accordingly, the first reading device 200 can determine an abnormality of the second reading device 400 (the upper scanner 421). In this manner, since the first reading device 200 determines the presence or absence of a loss in (T1) with reference to (T2), the first reading device 200 can determine an abnormality of the second reading device 400 regardless of the presence or absence of an abnormality of the first reading device 200.

The image forming system 30 of the present embodiment described above can achieve the following effects in addition to the effects of the first embodiment.

Even when an abnormality occurs in the reading of one or more colors in the second reading device 400, an abnormality can be determined.

By combining the fourth and fifth embodiments, it is also possible to determine an abnormality when there is an abnormality in both the first reading device 200 and the second reading device 400. The first reading device 200 and the second reading device 400 can control each other based on the respective reading results.

As described above, in the embodiment, the image forming system 30 and the method of controlling the image forming system 30 have been described. However, it is needless to say that those skilled in the art can appropriately add to, modify, and omit the present invention within the scope of the technical idea.

For example, in the first to fifth embodiments, a case has been described where the first reading device 200 or the second reading device 400 functions as a determiner. However, the present invention is not limited to such a case, and the controller 380 of the image forming apparatus 300 may be configured to function as a determiner.

The control program may be provided by a computer-readable recording medium, such as a USB memory, a flexible disk, or a CD-ROM, or may be provided online via a network, such as the Internet. In this case, the program recorded on the computer-readable recording medium is usually transferred to and stored in a memory, a storage, or the like. Alternatively, this inspection program may be provided, for example, as independent application software, or may be incorporated, as a function of a server, into software of each device.

Furthermore, a part or a whole of the processing executed by the inspection program in the embodiments can be replaced with hardware such as a circuit to be executed.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system comprising:
an image former that forms an image on a recording medium;
a first reader that is provided upstream of the image former in a conveyance direction of the recording medium and reads the recording medium; and
a second reader that is provided downstream of the image former in the conveyance direction of the recording medium and reads the recording medium, wherein
the first reader controls the second reader based on a reading result of the first reader, and
the second reader controls the first reader based on a reading result of the second reader.

2. An image forming system comprising:
an image former that forms an image on a recording medium;
a first reader that is provided upstream of the image former in a conveyance direction of the recording medium and reads the recording medium;
a second reader that is provided downstream of the image former in the conveyance direction of the recording medium and reads the recording medium; and
a determiner that determines an abnormality of at least one of the first reader or the second reader based on a reading result of the first reader and a reading result of the second reader.

3. The image forming system according to claim 2, wherein
the second reader reads the recording medium on which the image is formed by the image former, and
the determiner determines the abnormality of at least one of the first reader or the second reader based on a size of the recording medium based on the reading result of the first reader and a distance from an end of the recording medium in a sheet conveyance direction to the image formed based on the reading result of the second reader.

4. The image forming system according to claim 3, further comprising a detector that is provided upstream of the image former in the conveyance direction of the recording medium and detects a physical property of the recording medium, wherein
the determiner determines the abnormality of at least one of the first reader or the second reader based on a detection result of the detector.

5. The image forming system according to claim 2, further comprising a fixer that fixes the image formed by the image former to the recording medium, wherein
the second reader reads the recording medium after fixing by the fixer, and
the determiner determines the abnormality of the second reader based on the size of the recording medium based on the reading result of the first reader and a size of the recording medium based on the reading result of the second reader.

6. The image forming system according to claim 2, wherein the determiner determines the abnormality of at least one of the first reader or the second reader based on a color of the recording medium based on the reading result of the first reader or a color of the recording medium based on the reading result of the second reader.

7. The image forming system according to claim 6, wherein
the second reader reads the recording medium on which the image is formed by the image former, and
the determiner determines the abnormality of at least one of the first reader or the second reader based on image data of the image formed by the image former, a color based on the reading result of the first reader, and a color based on the reading result of the second reader.

8. The image forming system according to claim 2, wherein
the first reader controls the second reader based on the reading result of the first reader, and
the second reader controls the first reader based on the reading result of the second reader.

9. A method of controlling an image forming system including
an image former that forms an image on a recording medium,
a first reader that is provided upstream of the image former in a conveyance direction of the recording medium and reads the recording medium, and
a second reader that is provided downstream of the image former in the conveyance direction of the recording medium and reads the recording medium, the method comprising:
reading a recording medium on which no image is formed by the first reader;
forming an image on the recording medium by the image former;
reading the recording medium on which the image is formed by the second reader; and
controlling the second reader by the first reader based on a reading result of the first reader and controlling the first reader by the second reader based on a reading result of the second reader.

10. A method of controlling an image forming system including
an image former that forms an image on a recording medium,
a first reader that is provided upstream of the image former in a conveyance direction of the recording medium and reads the recording medium, and
a second reader that is provided downstream of the image former in the conveyance direction of the recording medium and reads the recording medium, the method comprising:
reading a recording medium on which no image is formed by the first reader;
forming an image on the recording medium by the image former;
reading the recording medium on which the image is formed by the second reader; and
determining an abnormality of at least one of the first reader or the second reader based on a reading result of the first reader and a reading result of the second reader.
